(19) United States
(12) Patent Application Publication
(10) Pub. No.: US 2013/0011311 A1
(43) Pub. Date: Jan. 10, 2013

(54) Blood Component Separator

(76) Inventor: Jun-Woo Kim, Daegu (KR)

(21) Appl. No.: 13/636,672

(22) PCT Filed: Dec. 31, 2010
(86) PCT No.: PCT/KR2010/009611

§ 371 Date: Sep. 21, 2012

(30) Foreign Application Priority Data
Mar. 23, 2010 (KR) 10-2010-0025698

(51) Int. Cl. B04B 7/00

(52) U.S. Cl. 422/548

(57) ABSTRACT

The present invention relates to blood component separator whereby it is possible to simplify the process compared to the related art as well as guarantee the purity of the separated blood components, and prevent contamination by ambient air during the process from blood collection to blood component separation. The blood component separator includes a body made of a cylinder at one end of which is formed a flow tube for blood to flow therethrough and on the other end of which is formed a female screw; a plunger which moves forward and backward inside the body to generate positive pressure or negative pressure between the flow tube and the plunger; and a push screw which is detachably connected to the plunger and has a thread portion screwed with the female screw of the body.

### TECHNICAL FIELD

The present invention relates to a blood component separator, and more specifically to a blood component separator whereby it is possible to simplify the process compared to the related art as well as guarantee the purity of the separated blood components, and prevent contamination by ambient air during the process from blood collection to blood component separation.

### BACKGROUND ART

Blood is divided largely into blood cells and plasma. The blood cells consist of red blood cells, white blood cells and platelets, and the plasma consists mainly of water including a blood coagulation factor, electrolyte, etc. which are indispensable for maintaining life.

The processes of separating blood to extract the component elements are widely used for various medical purposes. Among them, a process of centrifugally separating blood by using specific gravity differences of blood components by a centrifuge and a process of extracting component elements by using specific composites are widely used.

The centrifugal separation process means a process of separating layer by layer each of the blood components that compose blood by using specific gravity differences while rotating at a velocity of approximately 10,000 rpm. If blood is centrifugally separated, the heaviest blood cells form the bottom layer, and above it are formed layers of white blood cells and platelets, and above the platelet layer is formed a plasma layer or serum layer.

In this case, the plasma rich with platelets called PRP (platelet rich plasma) is located relatively below the plasma and contains growth factors such as cytokine, PDGF, TGF-BETA1 and VEGP. It is clarified in data such as theses and dissertations that the plasma shows good effects in healing skin diseases and wounds in particular.

In addition, plasma with few platelets known as PPP (platelet poor plasma) is used in auto blood filler applications or auto plasma derived cosmetics. The auto blood filler is used in medical operations in which it is changed into a PPP gel form through adding temperature treatment and then injected into the skin.

The actual circumstances are that such a specific operation needs a more convenient and advanced method for extracting specific components from blood.

The method according to the related art for separating blood components will be described with reference to FIG. 1. In the method according to the related art for separating blood components, blood is first collected from the human body 10 with a syringe for centrifugally separating blood components (hereinafter, “a centrifugation syringe”) 100. The centrifugation syringe 100 has been commercialized, and includes a cylinder 120 with a flange 122 formed at the top end portion thereof, a plunger 114 sliding along the inner wall of the cylinder 120, and a piston rod 110 with one end fixed to the plunger 114 and moving into and out of the cylinder. And in the bottom end portion of the cylinder 120 is fixed an injection needle 130. Accordingly, blood collection is possible by pulling the piston rod 110 back.

It is also possible to inject blood into the centrifugation syringe 100 from a blood collection syringe by connecting the blood collection syringe and the centrifugation syringe 100 through a connector (not shown) after collecting blood by an extra blood collection syringe (not shown).

In addition, the bottom end portion of the centrifugation syringe 100 with blood introduced therein is closed with a stopper 140, and is inserted into the mount hole 22 of a centrifuge 20. At this time, the length of the piston rod 110 is too long to be inserted into the centrifuge 20 to make centrifugal separation difficult, so it is necessary to shorten the length. For this, one or more kerfs 112 are formed on the piston rod 110. If force is applied to the piston rod 110 in the direction perpendicular to the lengthwise direction of the piston rod 110, stress is concentrated at the kerf 112 causing the piston rod 110 to break.

The blood separated by component by the centrifuge 20 is separated forming layers in the order of blood cells 1, white cells and platelets 2 and plasma 3 from below according to the specific gravity differences.

After taking out the centrifugation syringe 100 containing blood components separated in multilayers from the centrifuge 20, the centrifugation syringe 100 is connected in sequence to extra syringes for storage blood (hereinafter, “blood storage syringes”) 160, 170 and 180 by connectors 150, 152 and 154.

First, connect the blood storage syringe 160 to the centrifugation syringe 100 by the connector 150. If the piston rod 166 of the blood storage syringe 160 is pulled, negative pressure is formed in the blood storage syringe 160, and blood cells 1 located in the lower portion of the centrifugation syringe 100 move into the blood storage syringe 160.

Next, when all of the blood cells 1 are extracted from the centrifugation syringe 100, connect again a new blood storage syringe 170 to the centrifugation syringe 100 by the connector 152. If the piston rod 176 of the blood storage syringe 170 is pulled, PRP enriched with platelets 2 moves from the centrifugation syringe 100 to the blood storage syringe 170.

Lastly, connect again a new blood storage syringe 180 to the centrifugation syringe 100 by the connector 154. If the piston rod 186 of the blood storage syringe 180 is pulled, PRP with decreased levels of platelets moves from the centrifugation syringe 100 to the blood storage syringe 180.

Accordingly, it is possible to separate out the blood cells, PRP and PPP from blood by way of the process as described above.

However, because in such a method for separating blood components using centrifugal separation, the blood cells are separated using the syringe mainly by the operator while observing with the naked eye, there is a problem that the plasma components are accidently mixed together with the separated blood cells or blood cell components are included in the plasma so that the purity of plasma drops. In particular, pressure is applied to the centrifugation syringe 100 from above, or the piston rod of the blood storage syringe 170 is pulled downward, so that negative pressure is formed in the syringe. In this state, if drawn out one by one beginning with the blood cells on the bottom, a density current is generated by density differences in the blood, as negative pressure which acted on the separated blood is then released from it. The blood components separated in this way are mixed again, and if residues of blood cells remain on the wall surface of the syringe cylinder from which blood cells were drawn out, it is difficult to get pure PPP or PRP.

Due to such a problem in the related art, a cumbersome process of raising the purity is performed additionally by removing the blood cells from the separated PRP and PPP again by a separator.

Another problem is that when extracting blood cells by applying pressure to the piston rod of the syringe, it is difficult to minutely adjust the quantity of the blood cells or plasma to be extracted. Therefore, it is difficult to surely separate the platelet domain that occupies a considerably small quantity in the whole blood, that is, the PRP portion only, and the results of this relies on the skillfulness of the operator.

### DISCLOSURE

### Technical Problem

Accordingly, to solve the above-mentioned problems, it is an object of the present invention to provide blood component separator whereby it is possible to simplify the process compared to the related art as well as guarantee the purity of the separated blood components, and prevent contamination by ambient air during the process from blood collection to blood component separation.

### Technical Solution

In order to accomplish the foregoing objects, according to an embodiment of the present invention, there is provided a method for separating blood components including the steps of: introducing blood into a blood component separator for inflowing and drawing blood through a flow tube and discharging contained blood through the flow tube by a pressing means; mounting the blood component separator with blood introduced on a centrifuge such that the flow tube of the blood component separator is oriented upward to centrifugally separate the blood in multilayers according to the blood components; connecting a PPP storage means to the flow tube of the blood component separator such that the flow tube is oriented upward, and pressing the centrifugally separated blood components upward by the pressing means to inject only PPP into the PPP storage means through the flow tube; and after separating the PPP, connect a PRP storage means to the flow tube of the blood component separator such that the flow tube is oriented upward, and pressing the centrifugally separated blood components upward by the pressing means to inject only PRP into the PRP storage means through the flow tube.

Preferably, in the blood introducing step, the blood is collected directly from a human body by using an injection needle fixed to the blood component separator.

Preferably, in the blood introducing step, the blood collected from the human body by a blood collection syringe is injected into the blood component separator.

Preferably, the PPP storage means or the PRP storage means is a blood storage syringe.

Preferably, the blood component separator includes a body made of a cylinder at one end of which is formed a flow tube for blood to flow therethrough and on the other end of which is formed a female screw; a plunger which moves forward and backward inside the body and generates positive pressure or negative pressure between the flow tube and the plunger; and a push screw which is detachably connected to the plunger and has a thread portion screwed with the female screw of the body, and at the front end of which is formed a first offset portion that is not screwed with the female screw of the body.

In addition, a blood component separator includes: a body made of a cylinder at one end of which is formed a flow tube for blood to flow therethrough and on the other end of which is formed a female screw; a plunger which moves forward and backward inside the body and generates positive pressure or negative pressure between the flow tube and the plunger; and a push screw which is detachably connected to the plunger and has a thread portion screwed with the female screw of the body.

The blood component separator further includes a push rod that passes through the inside of the female screw of the body to be joined with the plunger, in a state in which the push rod is removed from the plunger, wherein the push rod is detachably connected to the plunger.

Preferably, the plunger has a fixing screw formed thereon, and the push rod has a second fixing portion formed at the front end portion thereof to be screwed with the fixing screw.

Preferably, the plunger has a fixing screw formed thereon, and the push screw has a first fixing portion formed at the front end portion thereof to be screwed with the fixing screw.

Preferably, at the other end of the body is mounted a plunger retaining cap that prevents the blood inside from leaking as the plunger is broken away, in a state in which the push screw is removed from the plunger, wherein the plunger retaining cap comprises a cap male screw which is screwed with the female screw of the body, and a head portion which is integrally formed with the cap male screw to contact with the other end of the body in an assembled state.

According to the present invention, it is possible to reduce the time and cost required in the separation work of the blood components. In particular, by separating by applying pressure upward in the order of PPP and PRP that have light specific gravity, the mixing of the blood cells is completely prevented, and the degree of purity of separated PRP and PPP is high.

In the case of separating the PRP and PPP which are used mainly for analyzing the blood components, it is possible to reduce the number of blood storage syringes that are in service.

In addition, since blood components are moved in a state isolated from ambient air by a coupler between the blood component separator and the blood storage syringe, it is possible to prevent contamination by ambient air. Therefore, it is possible to prevent infection of pathogens or complications that may occur due to air contamination of blood in the blood separation process.

### DESCRIPTION OF DRAWINGS

The above objects, features and advantages of the present invention will become more apparent to those skilled in the related art in conjunction with the accompanying drawings. In the drawings:

FIG. 1 is a schematic view of a method for separating blood components according to the related art;

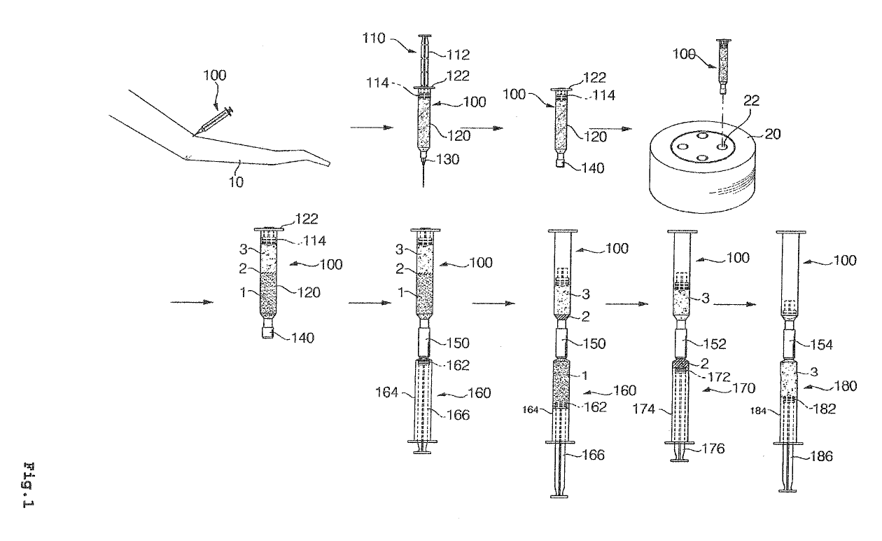

FIG. 2 is a schematic view of a method for separating blood components according to the present invention;

FIG. 3 is an exploded perspective view as seen from one side of a blood component separator used in the method for separating blood components of 2;

FIG. 4 is an exploded perspective view as seen from the other side of a blood component separator used in the method for separating blood components of 2;

FIG. 5 is a sectional view of the state in which an injection needle is mounted on the blood component separator used in the method for separating blood components of 2;

FIG. 6 is a sectional view of the state in which a coupler is mounted on the blood component separator used in the method for separating blood components of 2; and

FIG. 7 is a sectional view of a state in which another coupler is mounted on the blood component separator used in the method for separating blood components of 2.

### BEST MODE

The present invention will now be described more fully hereinafter with reference to the accompanying drawings forming a part of this specification wherein like reference characters designate corresponding parts in the several views. In the embodiments of the present invention, detailed description of the publicly known functions and configurations that are judged to be able to make the purport of the present invention unnecessarily obscure are omitted.

In the related art, the blood is put in the upper side and an extra blood storage syringe is placed below in a state in which the blood forms layers according to the blood components after centrifugal separation. In this state, it was possible to find out that the major cause for many problems occurring is because the blood cells were removed downward from the upper side beginning with those that are in the lower portion. Therefore, the core of the present invention is to put the blood in the lower portion and place extra blood storage syringes in the upper side in a state in which the blood forms layers according to the blood components after centrifugal separation. In this state, the blood is separated upward beginning with the plasma (or PPP) that is in the upper portion.

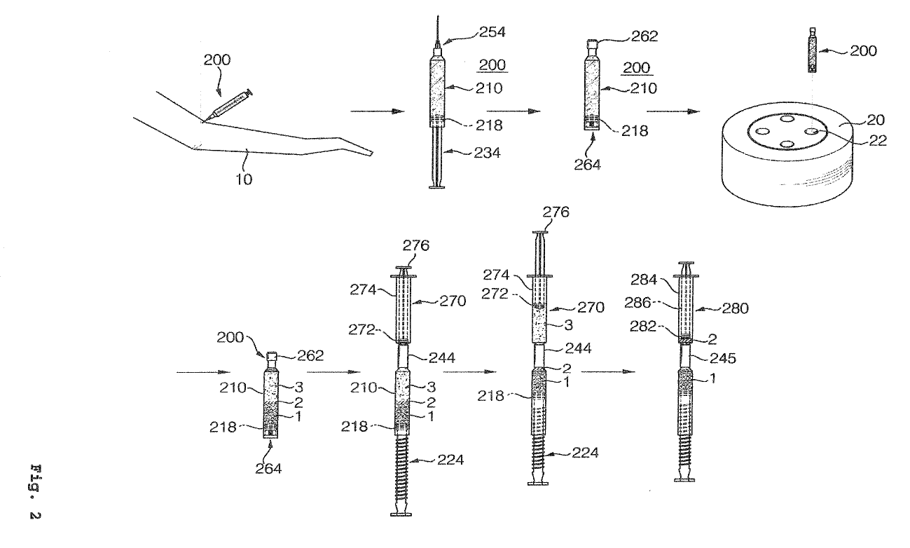

Namely, the method for separating blood components according to the present invention can be carried out in the order as shown in FIG. 2.

First, in the blood collection step, a blood collection syringe or a blood component separator 200 of substantially cylindrical shape disclosed in the present invention may be used. The blood component separator 200 will be described later. The blood collection step is for collecting a given quantity of blood from the human body 10, and in the case of the blood component separator 200, a detachable injection needle 254 is used. The injection needle 254 includes a needle holder 258 mounted on the blood component separator 200 and a needle 256 mounted in the needle holder 258.

After injecting the blood collected by the blood collection syringe into the blood component separator 200 or collecting blood directly from the human body 10 using the blood component separator 200, remove the push rod 234 and/or the injection needle 254 from the blood component separator 200 filled with blood (blood introducing step).

Cover the flow tube 214 of the blood component separator 200 with a sealing cap 262, so that the blood in the blood component separator 200 is completely isolated from ambient air by a plunger 218 and the sealing cap 262 (centrifugal separation preliminary step). If the blood component separator 200 operates while it is mounted on the centrifuge 20, there is a fear that the plunger 218 may be pushed by centrifugal force causing blood to leak. In order to prevent the leaking of blood, it is preferable to fix a plunger-retaining cap 264 to the blood component separator 200. The plunger-retaining cap 264 will be described below.

Then, insert the blood component separator 200 into the mount hole 22 of the centrifuge 20. When the centrifuge 20 is operated, the blood in the blood component separator 200 is layer-separated in the order of the blood cells 1, white blood cells and platelets 2 and plasma 3 (centrifugal separation step).

Next, connect a push screw 224 to the plunger 218 of the blood component separator 200, and separate the sealing cap 262 from the flow tube 214. After that, connect the blood storage syringe 270 to the flow tube 214 by a coupler 244 for blood to flow (PPP separation preliminary step).

After this, firstly, move plasma 3 (or PPP) located in the upper side of the body 210 of the blood component separator 200 into the blood storage syringe 270 using the push screw 224 (PPP separation step).

Subsequently, separate the blood storage syringe 270 from the coupler 244, and separate the coupler 244 as well from the blood component separator 200. Then, connect the blood storage syringe 280 by a new coupler 245 to the flow tube 214 (PRP separation preliminary step).

Secondly, move the white blood cells and platelets 2 (or PRP) located in the upper side of the body 210 of the blood component separator 200 into the blood storage syringe 280 using the push screw 224 (PRP separation step).

Accordingly, through such processes, PPP and PRP of high purity fill the two blood storage syringes 270 and 280, respectively. In this case, the mixing of blood cells due to specific gravity differences is prevented in the process that PRP or PPP is moving, and because blood cells do not move in the domain where PPP or PRP is moving, PPP and PRP of higher purity can be collected.

In addition, it is possible to use as necessary or discard the blood cells 1 remaining in the blood component separator 200.

As described above, since the coupler is used during the movement of blood or blood components during the process from blood collection to blood component separation, the blood is not exposed to the outside, so contamination by the ambient air can be prevented.

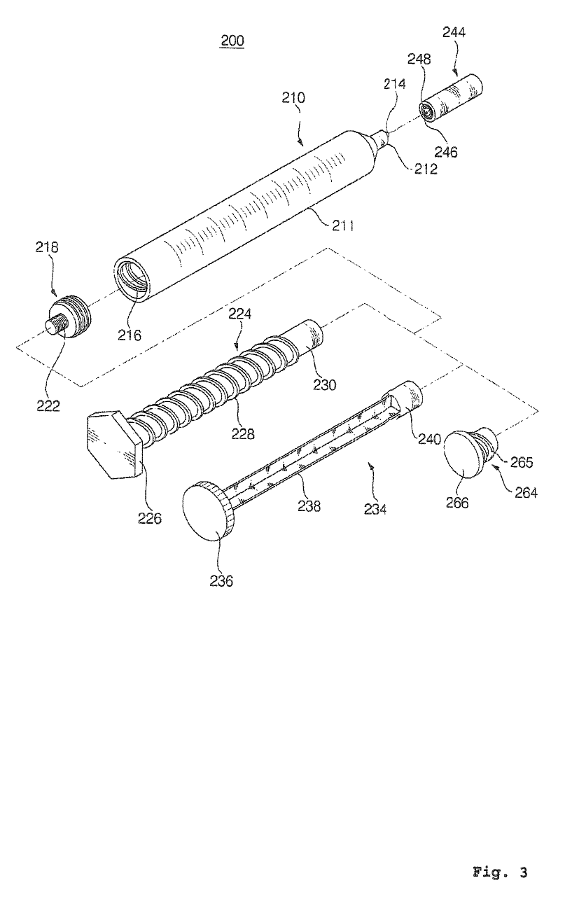

Below the structure of the blood component separator 200 will be described with reference to FIGS. 3 to 6.

The blood component separator 200 is characterized basically by the possibility of precisely discharging the blood components as well as the possibility of blood collection.

The blood component separator 200 having such characteristics includes a body 210 of substantially cylindrical shape at one end of which is formed the flow tube 214 for blood to flow therethrough and on the inside at the other end of which is formed a female screw 216 for fixing, the plunger 218 for generating positive pressure or negative pressure between the flow tube 214 and the plunger while moving forward and backward in the body 210, and the push screw 224 or the push rod 234 selectively fixed to the plunger 218.

The body 210 is made of a transparent cylinder 211, and graduations may be marked on the outer circumference of the cylinder 211 for checking the flow amount of the blood components.

The flow tube 214 provided at one end of the body 210 is elongated in protrusion from the body 210, and around the flow tube 214 is formed a fixing protrusion 212 for fixing the injection needle 254 or the couplers 244 and 245. Especially, it is preferable to form the body 210 in such a way that there is no portion extended out of the radial direction so that it is easily inserted into the mount hole 22 of the centrifuge 20. In order for the user not to slip while grasping the body, it is preferable to mold the shape of the cylinder 211 in a polygonal form or knurl the outer surface thereof.

On the inside of the other end of the body 210 is formed a female screw 216, which may also play a role as a stopper for preventing the plunger 218 from breaking away.

The plunger 218 has a fixing screw 222 formed on one side of the plunger body of a schematically disk shape, that is, on the opposite side of the flow tube 214, so as to be screwed with the push screw 224 or the push rod 234. The fixing screw 222 may be a female screw or a male screw. In the push screw 224 or the push rod 234 is formed respectively a first fixing portion 232 or a second fixing portion 242 having a shape corresponding to the fixing screw 222. In the embodiment of the present invention, the fixing screw 222 is a male screw, and the first fixing portion 232 and the second fixing portion 242 illustrate the shape of a female screw.

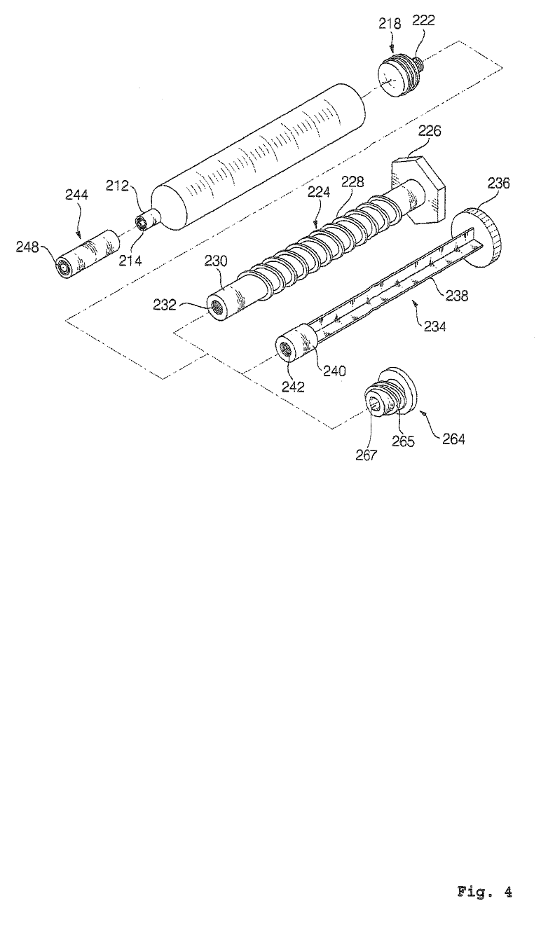

As shown in FIGS. 3 and 4, it is preferable that the plunger 218 has three or more ring-shaped protrusions for sealing blood. An ordinary syringe has two ring-shaped protrusions, but the blood component separator 200 has centrifugal force acting in the centrifuge 20, so it is advantageous to increase the number of ring-shaped protrusions and the thickness of the plunger 218 to prevent the leaking of blood to the inside thereof.

The push screw 224 includes a threaded portion 228 formed on the screw body and a knob 226 for rotating the threaded portion 228. The threaded portion 228 is screwed to the female screw 216.

Especially, at the front end portion of the push screw 224 is provided a first offset portion 230 that has a threaded portion not formed, so the screwing of the female screw 216 and the screw portion 228 can be avoided during the connection with the plunger 218. Accordingly, the length of the first offset portion 230 should be equal to or longer than the length of the female screw 216.

And on the inside of the first offset portion 230 is formed the first fixing portion 232. And the knob 226 is a portion in which the user grasps it by hand to rotate the push screw 224, and it may be formed in circular form or polygonal form.

The push rod 234 includes a rod body 238 forming a frame and a knob 236 formed at one end of the rod body.

It is preferable to form the rod body 238 in a framework shape in order to lighten weight and save material. In the embodiment of the present invention, the cross section of the rod body is made of cruciform framework. At this time, the imaginary circumscribed circle making the cruciform framework should be smaller than the minimum cross section of the female screw 216. Namely, the cruciform framework is not to touch the female screw 216, so that it should be easy to insert into the body 210.

The knob 236 is a portion in which the user grasps the rod body 238 by hand and it may be formed in circular form or polygonal form.

At the front end of the push rod 234 may be formed a second offset portion 240 corresponding to the first offset portion 230 of the push screw 224. Preferably, the second offset portion 240 has a cross section formed in schematically circular form and is supported by the female screw 216 so that the push rod 234 can be rotated stably.

On the inside of the second offset portion 240 is formed the second fixing portion 242 that screws with the fixing screw 222 of the plunger 218.

The plunger-retaining cap 264 is mounted on the body 210 to prevent the blood inside from leaking if the plunger 218 is broken away by centrifugal force during operation, in the state in which the blood component separator 200 is mounted on the centrifuge 20. In the plunger retaining cap 264 is formed a cap male screw 265 that can be screwed with the female screw 216, and a head portion 266 is integrally formed with the cap male screw 265. The head portion 266 contacts with the other end of the cylinder 211 in an assembled state and has an outer diameter schematically equal to the outer diameter of the cylinder 211. In the center of the cap male screw 265 is formed an allowance hole 267, so that the fixing screw 222 of the plunger 218 can be inserted therein.

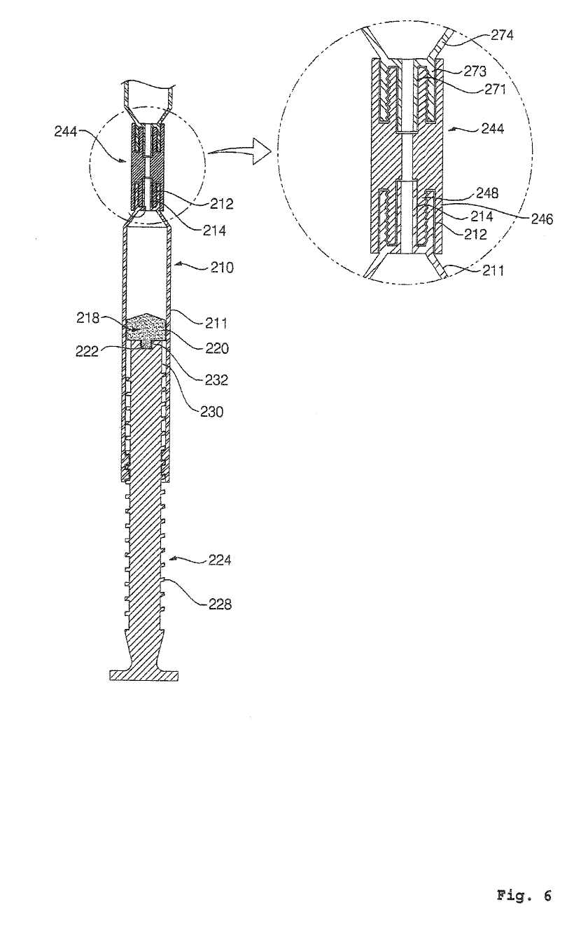

In each of the couplers 244 and 245, as shown in FIG. 6, the flow tubes 214 are inserted on both sides, and a connecting tube 248, which joins with the fixing protrusion 212 formed on the outside of the flow tube 214, is formed. On the outside of the connecting tube 248 is formed a retaining tube 246 into which the fixing protrusion 212 is inserted. The retaining tubes 246 formed at both ends communicate with each other, so that blood or blood components can move without contact with ambient air in both of the blood storage syringes 270 and 280 and the blood component separator 200 connected by the couplers 244 and 245. In the couplers 244 and 245, as shown in FIG. 6, it is possible to join the connecting tube 248 and the fixing tube 273, since the fixing tube 273 is formed around a protruded tube 271 of the blood storage syringes 270 and 280.

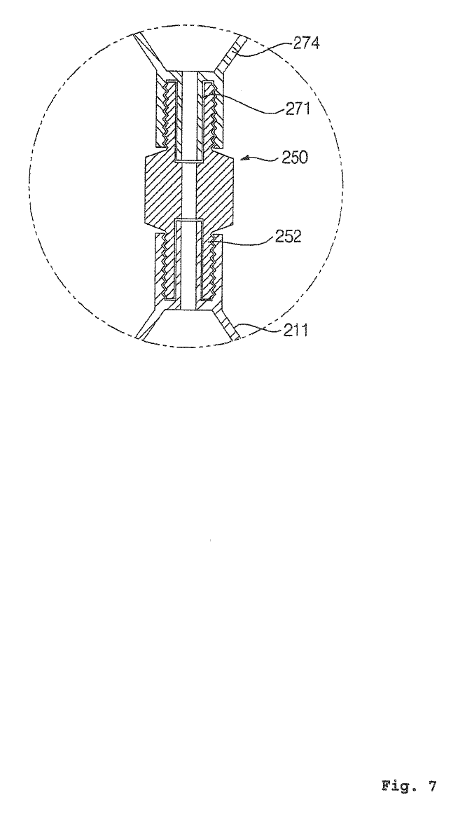

As shown in FIG. 7, another form is also possible, in which the flow tubes 214 are inserted into both ends of the coupler 250 and only the connecting tube 252 joining with the fixing protrusion 212 formed on the outside of the flow tube 214 is formed. Therefore, the coupler 250 is easier to manufacture compared to the couplers 244 and 245.

The couplers 244, 245 and 250 are preferably made of transparent material so that the operator can observe what the moving of the blood components looks like.

The injection needle 254 includes the needle 256 and the needle holder 258 fixed to the fixing protrusion 212 of the body for fixing the needle 256.

Next, the method of using the blood component separator 200 configured as described above will be described with reference to FIGS. 3 to 6.

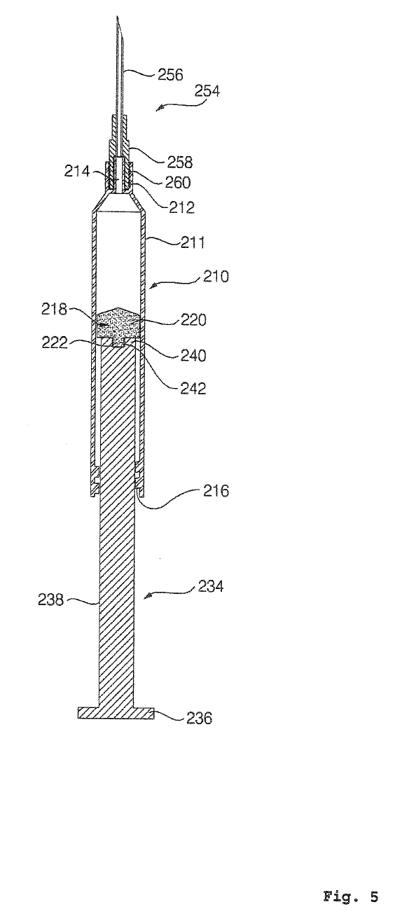

First, in the case of collecting blood using the blood component separator 200, as shown in FIG. 5, connect the injection needle 254 to the flow tube 214 of the blood component separator 200. At this time, the needle holder 258 of the injection needle 254 is screwed to the fixing protrusion 212. And the plunger 218 is integrally connected to the push rod 234 by screwing of the fixing screw 222 of the plunger 218 and the second fixing portion 242 of the push rod 234. The state in which the plunger 218 is pushed all the way to the end by the push rod 234 is the state in which blood collection is ready.

In the case of mounting the blood component separator 200 to the centrifuge 20, separate the injection needle 254 from the flow tube 214, and also separate the push rod 234 from the plunger 218. Then, fix the sealing cap 262 to the flow tube 214 for covering it. In the sealing cap 262 is formed a joining means (not shown) screwed to the fixing protrusion 212. And the sealing cap 262 is in the form of single tube for inserting only the flow tube 214 by friction contact without a joining means like a screw, but it may also be configured in a form of double tubes for inserting the flow tube 214 and the fixing protrusion 212 simultaneously. Then, insert the plunger retaining cap 264 into the body 210. The plunger retaining cap 264 may be mounted by a method of screwing with the female screw 216 or by a method of inserting the other end portion of the cylinder 211 and joining by friction contact.

Next, the push screw 224 is operatively installed in the blood component separator 200 that has gone through the centrifuge 20 by screwing it to the fixing screw 222 of the plunger 218. At this time, it is possible to avoid the female screw 216 and the threaded portion 228 being screwed with each other, until the fixing screw 222 is completely fixed to the first fixing portion 232 by the first offset portion 230.

In addition, by rotating the push screw 224 little by little, it is possible to extract into the blood storage syringes 270 and 280 only the desired blood components among the separated blood components included in the body 210.

### DESCRIPTION OF REFERENCE NUMERALS IN DRAWINGS

1: Blood cell, 2: White cell and platelet
3: Plasma, 10: Human body
20: Centrifuge, 22: Mount hole
100: Centrifugation syringe, 110: Piston rod
112: Kerf, 114: Plunger
120: Cylinder, 122: Flange
140: Stopper, 150, 152, 154: Connector
160, 170, 180: Blood storage syringe
162, 172, 182: Plunger
164, 174, 184: Piston rod, 200: Blood component separator
210: body, 211: Cylinder
212: Fixing protrusion, 214: Flow tube
216: Female screw, 218: Plunger
222: Fixing screw, 224: Push screw
226: Knob, 228: Threaded portion
230: First offset portion, 232: First fixing portion
234: Push rod, 236: Knob
238: Rod body, 240: Second offset portion
242: Second fixing portion, 244, 245, 250: Coupler
246: Retaining tube, 248, 252: Connecting tube
254: Injection needle, 256: Needle
258: Needle holder, 262: Sealing cap
264: Plunger retaining cap, 265: Cap male screw
266: Head portion, 267: Allowance hole
270, 280: Blood storage syringe, 271: Protruded tube
272, 282: plunger, 273: Fixing tube
274, 284: Cylinder, 276: Piston rod

Although the present invention has been described in connection with the exemplary embodiments illustrated in the drawings, it is only illustrative. It will be understood by those skilled in the art that various modifications and equivalents can be made to the present invention. Therefore, the true technical scope of the present invention should be defined by the appended claims.

1. A blood component separator comprising:
a body made of a cylinder at one end of which is formed a flow tube for blood to flow therethrough and on the other end of which is formed a female screw;
a plunger which moves forward and backward inside the body and generates positive pressure or negative pressure between the flow tube and the plunger; and
a push screw which is detachably connected to the plunger and has a thread portion screwed with the female screw of the body.

2. The blood component separator of claim 1, further comprising a push rod that passes through the inside of the female screw of the body to be joined with the plunger, in a state in which the push rod is removed from the plunger, wherein the push rod is detachably connected to the plunger.

3. The blood component separator of claim 2, wherein the plunger has a fixing screw formed thereon, and the push rod has a second fixing portion formed at the front end portion thereof to be screwed with the fixing screw.

4. The blood component separator of claim 1, wherein the plunger has a fixing screw formed thereon, and the push screw has a first fixing portion formed at the front end portion thereof to be screwed with the fixing screw.

5. The blood component separator of claim 1, wherein at the other end of the body is mounted a plunger retaining cap that prevents the blood inside from leaking as the plunger is broken away, in a state in which the push screw is removed from the plunger, wherein the plunger retaining cap comprises a cap male screw which is screwed with the female screw of the body, and a head portion which is integrally formed with the cap male screw to contact with the other end of the body in an assembled state.
